(19) United States
(12) Patent Application Publication
(10) Pub. No.: US 2013/0163903 A1
(43) Pub. Date: Jun. 27, 2013

(54) HYDRODYNAMIC BEARING ASSEMBLY AND SPINDLE MOTOR INCLUDING THE SAME

(71) Applicants: Jong Ryeol OH, Seoul (KR); Dong Hyun Lee, Seoul (KR); Ho Kyung Jang, Suwon (KR)

(72) Inventors: Jong Ryeol OH, Seoul (KR); Dong Hyun Lee, Seoul (KR); Ho Kyung Jang, Suwon (KR)

(73) Assignee: SAMSUNG ELECTRO-MECHANICS CO., LTD., Suwon (KR)

(21) Appl. No.: 13/444,265

(22) Filed: Apr. 11, 2012

(30) Foreign Application Priority Data
Dec. 23, 2011 (KR) 10-2011-0141669

(51) Int. Cl. F16C 32/06

(52) U.S. Cl. 384/120

(57) ABSTRACT

There is provided a hydrodynamic bearing assembly including: a sleeve fixed to a base member and having a depression groove formed in a lower end portion thereof; and a shaft rotatably supported by the sleeve and having a stopper inserted in the depression groove, wherein the stopper includes a movement suppressing part provided on an outer peripheral surface thereof in order to suppress movements of a lubricating fluid.

### CROSS-REFERENCE TO RELATED APPLICATIONS

This application claims the priority of Korean Patent Application No. 10-2011-0141669 filed on Dec. 23, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A small-sized spindle motor used for a hard disk drive (HDD) generally includes a hydrodynamic bearing assembly, and a bearing clearance provided in the hydrodynamic bearing assembly is filled with a lubricating fluid.

In addition, at the time of rotation of a shaft, the lubricating fluid filling the bearing clearance is pumped to form fluid dynamic pressure, thereby rotatably supporting the shaft.

Meanwhile, the shaft may include a stopper in order to prevent the shaft from being separated from a sleeve at the time of external impacts.

Further, the shaft is floated toward an upper portion of the sleeve and then returned to its original position when impacts are applied from the outside thereto.

Further, the shaft returned to its original position continuously vibrates. However, the shaft does not include a structure of reducing this vibration, such that performance of the spindle motor is deteriorated due to the vibration.

In other words, since the vibration generated due to external impacts may not be reduced, the performance of the spindle motor is deteriorated due to the vibration.

In addition, the shaft may serve as a syringe through the movement thereof, such that the lubricating fluid is leaked from the bearing clearance. Thus, the development of a structure capable of suppressing movements of a lubricating fluid due to the movement of a shaft has been required.

### SUMMARY OF THE INVENTION

An aspect of the present invention provides a hydrodynamic bearing assembly capable of reducing vibrations generation due to external impacts, and a spindle motor including the same.

According to an aspect of the present invention, there is provided a hydrodynamic bearing assembly including: a sleeve fixed to a base member and having a depression groove formed in a lower end portion thereof; and a shaft rotatably supported by the sleeve and having a stopper inserted in the depression groove, wherein the stopper includes a movement suppressing part provided on an outer peripheral surface thereof in order to suppress movements of a lubricating fluid.

The movement suppressing part may be configured as a plurality of protrusions disposed to be spaced apart from each other in an axial direction.

Each of the plurality of protrusions configuring the movement suppressing part may have a quadrangular longitudinal cross-section.

The shaft may have a shaft body having a cylindrical shape and the stopper coupled to a lower end portion of the shaft body.

The shaft may have a shaft body having a cylindrical shape and the stopper extending from a lower end portion of the shaft body outwardly in a radial direction.

The hydrodynamic bearing assembly may further include a cover member installed on the sleeve so as to be disposed below the stopper.

According to another aspect of the present invention, there is provided a spindle motor including: a base member; a sleeve fixed to a base member and having a depression groove formed in a lower end portion thereof; and a shaft rotatably supported by the sleeve and having a stopper inserted in the depression groove, a cover member installed on the sleeve so as to be disposed below the stopper; and a rotor hub fixed to an upper end portion of the shaft to thereby rotate together with the shaft, wherein the stopper includes a movement suppressing part provided on an outer peripheral surface thereof in order to suppress movements of a lubricating fluid.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a hydrodynamic bearing assembly according to an embodiment of the present invention;

FIG. 2 is an enlarged view showing the part A of FIG. 1;

FIG. 3 is an exploded perspective view showing a shaft included in the hydrodynamic bearing assembly according to the embodiment of the present invention;

FIG. 4 is a view describing an operation of the hydrodynamic bearing assembly according to an embodiment of the present invention;

FIG. 5 is a schematic cross-sectional view showing a spindle motor including a hydrodynamic bearing assembly according to another embodiment of the present invention; and

FIG. 6 is an exploded perspective view showing a shaft included in the hydrodynamic bearing assembly according to another embodiment of the present invention.

### DETAILED DESCRIPTION OF THE EMBODIMENT

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

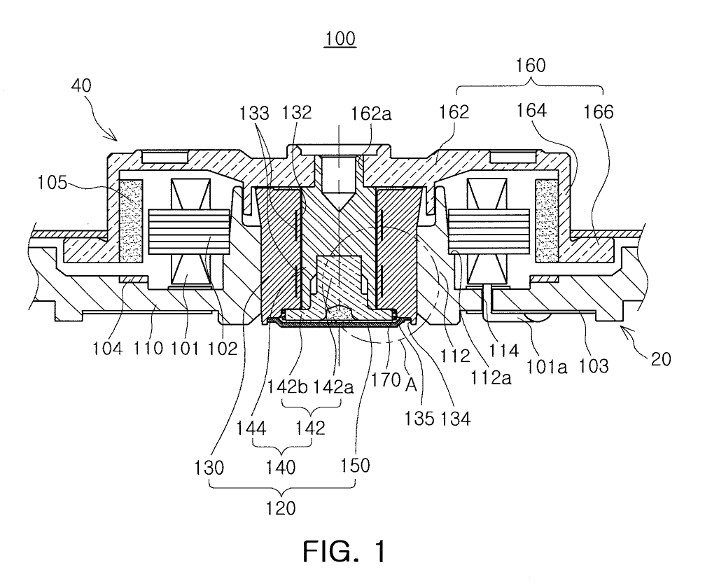

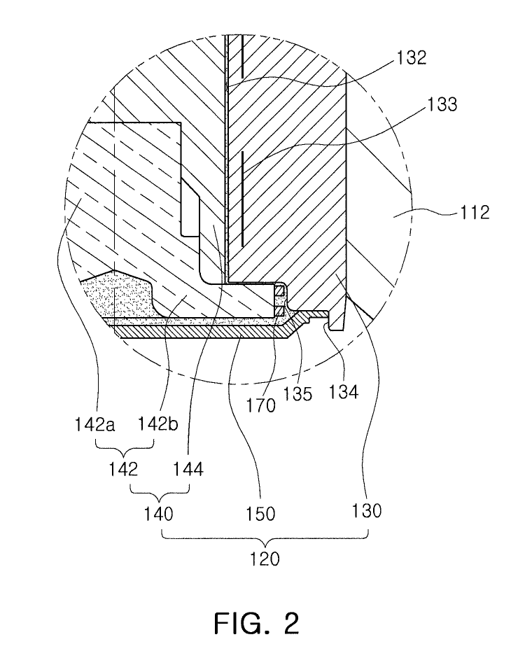

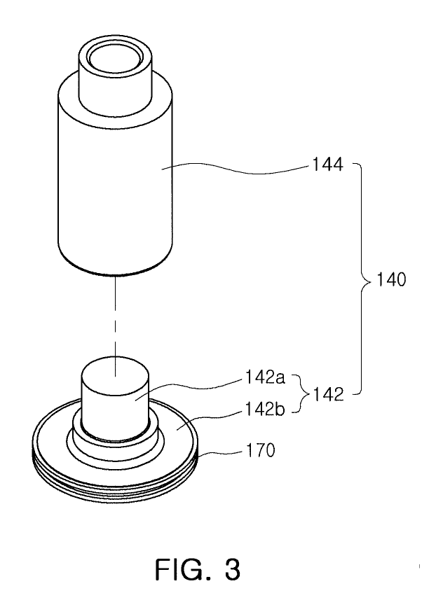

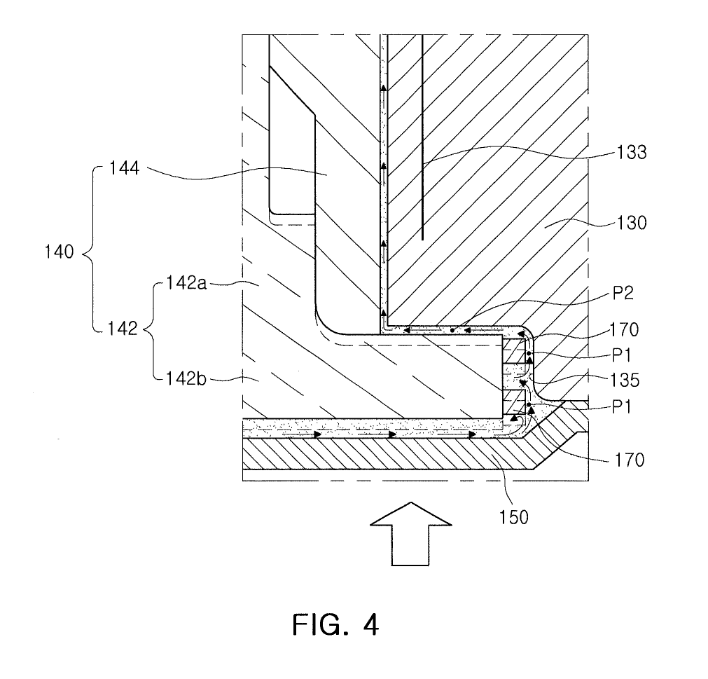

FIG. 1 is a schematic cross-sectional view showing a spindle motor including a hydrodynamic bearing assembly according to an embodiment of the present invention; FIG. 2 is an enlarged view showing the part A of FIG. 1; FIG. 3 is an exploded perspective view showing a shaft included in the hydrodynamic bearing assembly according to the embodiment of the present invention; and FIG. 4 is a view describing an operation of the hydrodynamic bearing assembly according to an embodiment of the present invention.

Referring to FIGS. 1 through 4, a spindle motor 100 according to an embodiment of the present invention may include a base member 110, a hydrodynamic bearing assembly 120, and a rotor hub 160 by way of example.

In addition, the hydrodynamic bearing assembly 120 according to the embodiment of the present invention may include a sleeve 130, a shaft 140, and a cover member 150 by way of example.

Meanwhile, the spindle motor 100 according to the embodiment of the present invention may be a motor used in a hard disk drive rotating a recording disk.

Here, terms with respect to directions will be defined.

As viewed in FIG. 1, an axial direction refers to a vertical direction, that is, a direction from an upper portion of the shaft 140 toward a lower portion thereof or a direction from the lower portion of the shaft 140 toward the upper portion thereof, and a radial direction refers to a horizontal direction, that is, a direction from an outer peripheral surface of a rotor hub 160 toward the shaft 140 or from the shaft 140 toward the outer peripheral surface of the rotor hub 160.

In addition, a circumferential direction refers to a rotation direction along the outer peripheral surface of the rotor hub 160 and the shaft 140.

Meanwhile, the spindle motor 100 according to the embodiment of the present invention may be mainly configured of a stator 20 and a rotor 40. The stator 20 indicates all fixed members rotatably supporting the rotor 40, and the rotor 40 indicates rotating members supported by the stator 20 to thereby rotate.

The base member 110, which is a fixed member included in the stator 20 rotatably supporting the rotor 40, may include an installation part 112 in which the sleeve 130 included in the hydrodynamic bearing assembly 120 is installed.

The installation part 112 may protrude upwardly in the axial direction, and the sleeve 130 may be insertedly installed in the installation part 112.

In addition, the installation part 112 may include a stator core 102 installed on an outer peripheral surface thereof, wherein the stator core 102 has a coil 101 wound therearound. That is, the stator core 102 may be mounted on a mounting surface 112a formed on the outer peripheral surface of the installation part 112 to be thereby fixedly installed thereon by an adhesive and/or welding.

Meanwhile, the base member 110 may include a lead-out hole 114 formed therein so as to be disposed in the vicinity of the installation part 112. In addition, a lead part 101a of the coil 101 wound around the stator core 102 may be led from an upper portion of the base member 110 toward a lower portion thereof through the lead-out hole 114.

In addition, the base member 110 may have a circuit board 103 installed on a lower surface thereof, the circuit board 103 having the lead part 101a of the coil 101 bonded thereto. In addition, the circuit board 103 may be a flexible circuit board.

Meanwhile, the base member 110 may include a pulling plate 104 installed thereon in order to prevent the rotor hub 160 from being excessively floated, wherein the pulling plate 104 may have an annular ring shape.

The hydrodynamic bearing assembly 120 may include the sleeve 130, the shaft 140, and the cover member 150 as described above and form a bearing clearance filled with a lubricating fluid.

In addition, the lubricating fluid filling the bearing clearance is pumped at the time of the rotation of the shaft 140, such that more stable rotation of the shaft 140 may be undertaken.

Meanwhile, the sleeve 130, which is a fixed member configuring the stator 20 together with the base member 110, may be fixed to the installation part 112. That is, an outer peripheral surface of the sleeve 130 may be adhered to an inner peripheral surface of the installation part 112 by an adhesive or the sleeve 120 may be press-fitted into the installation part 112.

Further, the sleeve 130 may include a shaft hole 132 formed therein so as to allow the shaft 140 to be inserted therein. That is, the sleeve 130 may have a hollow cylindrical shape.

Meanwhile, in the case in which the shaft 140 is inserted in the sleeve 130, an inner peripheral surface of the sleeve 130 and an outer peripheral surface of the shaft 140 may be spaced apart from each other by a predetermined interval to thereby form a bearing clearance therebetween. This bearing clearance is filled with the lubricating fluid.

In addition, the sleeve 130 may include a dynamic pressure groove 133 formed in an inner surface thereof in order to generate fluid dynamic pressure by pumping the lubricating fluid filling the bearing clearance described above at the time of the rotation of the shaft 140.

In addition, a lower end portion of the sleeve 130 may be provided with a mounting groove 134 in which the cover member 150 is installed and a depression groove 135 formed in a stepped manner from the mounting groove 134.

The detailed description thereof will be provided below.

The shaft 140, which is a rotating member configuring the rotor 40, may be rotatably supported by sleeve 130 and include a stopper 142 inserted in the depression groove 135 described above.

Meanwhile, the shaft 140 may have a shaft body 144 having a cylindrical shape and the stopper 142 coupled to a lower end portion of the shaft body 144, as shown in FIG. 3.

In addition, the shaft 140 may be inserted in the shaft hole 132 of the sleeve 130 and have an upper end portion disposed to protrude upwardly of the sleeve 130.

Further, the shaft 140 may have the rotor hub 160 fixed to the upper end portion thereof.

The stopper 142 may serve to prevent the shaft 140 from being separated from the sleeve 130 at the time of external impacts.

In addition, the stopper 142 may include a movement suppressing part 170 formed on an outer peripheral surface thereof in order to suppress movements of the lubricating fluid.

Meanwhile, the stopper 142 may include an insertion part 142a inserted in the shaft body 144 and a flange part 142b extending from a distal end of the insertion part 142a.

In addition, the movement suppressing part 170 may be formed on an outer peripheral surface of the flange part 142b. In addition, the movement suppressing part 170 may be configured as a plurality of protrusions disposed to be spaced apart from each other in the axial direction.

Further, each of the plurality of protrusions configuring the movement suppressing part 170 may have a quadrangular longitudinal cross-section. That is, the movement suppressing part 170 may be formed such that the longitudinal cross-section of each of the plurality of protrusions configuring the movement suppressing part 170 has a quadrangular shape with edges in order to suppress movements of the lubricating fluid at the time of external impacts.

Although the embodiment of the present invention describes a case in which the movement suppressing part 170 is configured as two protrusions and each of the plurality of protrusions configuring the movement suppressing part 170 has the quadrangular longitudinal cross-section by way of example, the present invention is not limited thereto.

That is, the movement suppressing part 170 may also be configured as two or more protrusions. In addition, the longitudinal cross-section of each of the plurality of protrusions configuring the movement suppressing part 170 may have any shape capable of suppressing the movements of the lubricating fluid and increasing pressure in a clearance between the movement suppressing part 170 and the sleeve 130.

Here, an operation of the movement suppressing part 170 will be described in more detail.

First, the shaft 140 is floated upwardly in the axial direction when an external impact is applied thereto. In this case, as shown in FIG. 4, the lubricating fluid filling between the shaft 140 and the cover member 150 also moves upwardly in the axial direction together with the shaft 140.

That is, the lubricating fluid filling between the shaft 140 and the cover member 150 is introduced into a clearance formed by an upper surface of the flange part 142b of the stopper 142 and the sleeve 130 through a clearance formed by the outer peripheral surface of the flange part 142b of the stopper 142 and the sleeve 130. Then, the lubricating fluid moves to a clearance formed by the shaft body 144 and the inner peripheral surface of the sleeve 130.

However, since the movement suppressing part 170 is provided on the flange part 142b, the movements of the lubricating fluid may be hindered, such that the movements of the lubricating fluid may be suppressed.

In addition, in the case in which an external impact is applied, pressure in the clearance (that is, a point P1 of FIG. 4) between the movement suppressing part 170 and the sleeve 130 may be increased by the movement suppressing part 170, and pressure in the clearance (that is, a point P2 of FIG. 4) between the flange part 142b and the sleeve 130 may also be increased by the floating of the shaft 140.

Therefore, vibrations of the shaft 140 due to the external impact may be further alleviated. That is, the increased pressure in the points P1 and P2 may serve as damping force alleviating the vibrations of the shaft 140.

In addition, since the movement suppressing part 170 is configured as the plurality of protrusions disposed to be spaced apart from each other in the axial direction, a pressure increase in at least two points may be generated. Therefore, the damping force alleviating the vibrations of the shaft 140 may act in at least two points.

As a result, the vibrations of the shaft 140 may be more stably alleviated.

In addition, since the movements of the lubricating fluid are suppressed at the time of the external impact, a decrease in the amount of lubricating fluid filling between the shaft 140 and the cover member 150 may be suppressed. Therefore, the lubricating fluid may serve to alleviate the impact at the time of the descent of the shaft 140.

As a result, the movements of the lubricating fluid may be suppressed, whereby rigidity may be increased and the damping force alleviating the vibrations of the shaft 140 may be further increased.

The cover member 150, which is a fixed member configuring the stator 20 together with the base member 110 and the sleeve 130, may be installed on the sleeve 130 so as to be disposed below the stopper 142. That is, the cover member 150 may be fixed into the mounting groove 134 of the sleeve 130.

In addition, an upper surface of the cover member 150 may be disposed to face a lower surface of the stopper 142, and a clearance between the upper surface of the cover member 150 and the lower surface of the stopper 142 may also be filled with the lubricating fluid.

In addition, the cover member 150 may serve to prevent the lubricating fluid filling the bearing clearance from being leaked to the lower end portion of the sleeve 130.

The rotor hub 160, which is a rotating member configuring the rotor 40 together with the shaft 140, may be fixed to the upper end portion of the shaft 140 to thereby rotate together with the shaft 140.

Meanwhile, the rotor hub 160 may include a body 162 having a disk shape, a magnet coupling part 164 extending from an edge of the body 162 downwardly in the axial direction, and a disk mounting part 166 extending from the magnet coupling part 164 in the radial direction and having a disk mounted thereon.

The body 162 may include a mounting hole 162a formed at a central portion thereof in order to be fixed to the shaft 140.

Meanwhile, the magnet mounting part 164 may have a driving magnet 105 installed on an inner surface thereof, wherein the driving magnet 105 is disposed to face a front end of the stator core 102 having the coil 101 wound therearound. In addition, the driving magnet 105 may have an annular ring shape and may be a permanent magnet generating magnetic force having a predetermined strength by alternately magnetizing an N pole and an S pole in the circumferential direction.

Here, rotational driving of the rotor hub 160 will be schematically described. When power is supplied to the coil 101 wound around the stator core 102, driving force capable of rotating the rotor hub 160 may be generated by electromagnetic interaction between the driving magnet 105 and the stator core 102 having the coil 101 wound therearound.

Therefore, the rotor hub 160 rotates, such that the shaft 140 to which the rotor hub 160 is fixed and coupled may rotate together with the rotor hub 160.

As described above, since the movement suppressing part 170 is provided on the flange part 142b, in the case in which the external impact is applied, the movements of the lubricating fluid may be hindered, such that the movements of the lubricating fluid may be suppressed.

In addition, in the case in which the external impact is applied, pressure in the clearance (that is, the point P1 of FIG. 4) between the movement suppressing part 170 and the sleeve 130 may be increased by the movement suppressing part 170, and pressure in the clearance (that is, the point P2 of FIG. 4) between the flange part 142b and the sleeve 130 may also be increased by the floating of the shaft 140.

Therefore, the vibrations of the shaft 140 due to the external impact may be further alleviated. That is, the increased pressure in the points P1 and P2 may serve as damping force alleviating the vibrations of the shaft 140.

As described above, the pressure in the point P1 may be increased by the movement suppressing part 170 as compared to the case in which the movement suppressing part 170 is not included, such that the vibrations of the shaft 140 may be further alleviated.

In addition, since the movements of the lubricating fluid may be suppressed at the time of the external impact, a decrease in the amount of lubricating fluid filling between the shaft 140 and the cover member 150 may be suppressed. Therefore, the lubricating fluid may serve to alleviate the impact at the time of the descent of the shaft 140.

As a result, the movements of the lubricating fluid may be suppressed, whereby rigidity may be increased and the damping force alleviating the vibrations of the shaft 140 may be further increased.

Hereinafter, a spindle motor including a hydrodynamic bearing assembly according to another embodiment of the present invention will be described with reference to the accompanying drawings. However, a detailed description of the same components as the above-mentioned components will be omitted and be replaced by the above-mentioned description.

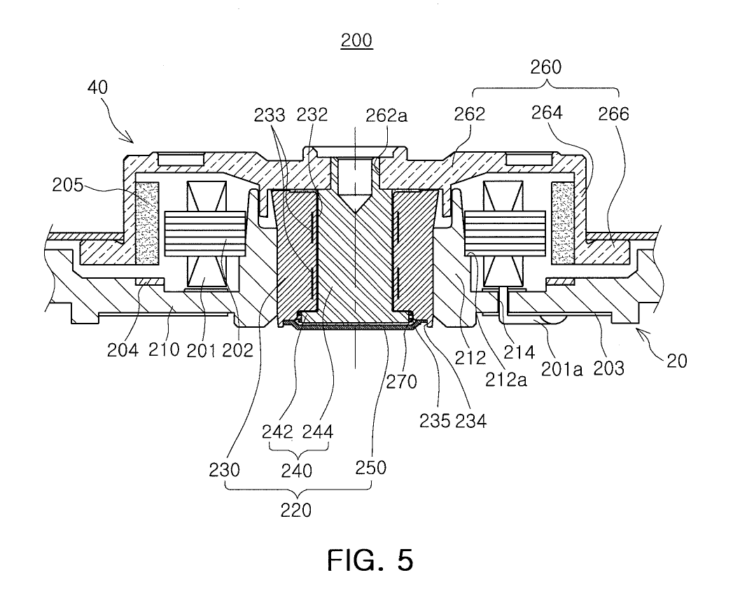

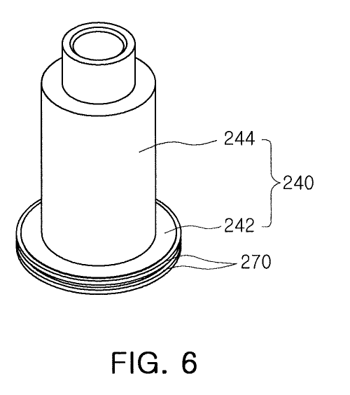

FIG. 5 is a schematic cross-sectional view showing a spindle motor including a hydrodynamic bearing assembly according to another embodiment of the present invention; and FIG. 6 is an exploded perspective view showing a shaft included in the hydrodynamic bearing assembly according to another embodiment of the present invention.

Referring to FIGS. 5 and 6, a spindle motor 200 according to another embodiment of the present invention may include a base member 210, a hydrodynamic bearing assembly 220, and a rotor hub 260 by way of example.

In addition, the hydrodynamic bearing assembly 220 according to another embodiment of the present invention may include a sleeve 230, a shaft 240, and a cover member 250 by way of example.

Meanwhile, the base member 210 and the rotor hub 260 included in the spindle motor 200 according to another embodiment of the present invention are substantially the same as the base member 110 and the rotor hub 160 included in the spindle motor 100 according to the foregoing embodiment of the present invention described above. Therefore, a detailed description thereof will be omitted.

In addition, the sleeve 230 and the cover member 250 included in the hydrodynamic bearing assembly 220 according to another embodiment of the present invention are substantially the same as the sleeve 130 and the cover member 150 included in the hydrodynamic bearing assembly 120 according to the foregoing embodiment of the present invention described above. Therefore, a detailed description thereof will be omitted and be replaced by the description described above.

The shaft 240, which is a rotating member configuring the rotor 40, may be rotatably by the sleeve 230 and include a stopper 242 inserted in a depression groove 235 described above.

Meanwhile, the shaft 240 may have a shaft body 244 having a cylindrical shape and the stopper 242 extending from a lower end portion of the shaft body 244 outwardly in the radial direction, as shown in FIG. 6.

In addition, the shaft 240 may be inserted in a shaft hole 232 of the sleeve 230 and have an upper end portion disposed to protrude upwardly of the sleeve 230.

Further, the shaft 240 may have the rotor hub 260 fixed to the upper end portion thereof.

The stopper 242 may serve to prevent the shaft 240 from being separated from the sleeve 230 at the time of an external impact.

In addition, the stopper 242 may include a movement suppressing part 270 formed on an outer peripheral surface thereof in order to suppress movements of the lubricating fluid.

In addition, the movement suppressing part 270 may be configured as a plurality of protrusions disposed to be spaced apart from each other in the axial direction.

Further, each of the plurality of protrusions configuring the movement suppressing part 270 may have a quadrangular longitudinal cross-section. That is, the movement suppressing part 270 may be formed such that the longitudinal cross-section of each of the plurality of protrusions configuring the movement suppressing part 270 has a quadrangular shape with edges in order to suppress movements of the lubricating fluid at the time of external impacts.

Although the embodiment of the present invention also describes a case in which the movement suppressing part 270 is configured as two protrusions and each of the plurality of protrusions configuring the movement suppressing part 270 has the quadrangular longitudinal cross-section by way of example, the present invention is not limited thereto.

That is, the movement suppressing part 270 may also be configured as two or more protrusions. In addition, the longitudinal cross-section of each of the plurality of protrusions configuring the movement suppressing part 270 may have any shape capable of suppressing the movements of the lubricating fluid and increasing pressure in a clearance between the movement suppressing part 270 and the sleeve 230.

Here, an operation of the movement suppressing part 270 will be described in more detail.

First, the shaft 240 is floated upwardly in the axial direction when an external impact is applied thereto. In this case, the lubricating fluid filling between the shaft 240 and the cover member 250 also moves upwardly in the axial direction together with the shaft 240.

That is, the lubricating fluid filled between the shaft 240 and the cover member 250 is introduced into a clearance formed by an upper surface of the stopper 242 and the sleeve 230 through a clearance formed by an outer peripheral surface of the stopper 242 and the sleeve 230. Then, the lubricating fluid moves to a clearance formed by the shaft body 244 and an inner peripheral surface of the sleeve 230.

However, since the movement suppressing part 270 is provided on the outer peripheral surface of the stopper 242, the movements of the lubricating fluid may be hindered, such that the movements of the lubricating fluid may be suppressed.

In addition, in the case in which the external impact is applied, the pressure in the clearance between the movement suppressing part 270 and the sleeve 230 may be increased by the movement suppressing part 270, and the pressure in the clearance between the stopper 242 and the sleeve 230 may also be increased by the floating of the shaft 240.

Therefore, the vibrations of the shaft 240 due to the external impact may be further alleviated. That is, the increased pressure in the points P1 and P2 (See FIG. 4) may serve as damping force alleviating the vibrations of the shaft 240.

In addition, since the movement suppressing part 270 is configured as the plurality of protrusions disposed to be spaced apart from each other in the axial direction, a pressure increase in at least two points may be generated. Therefore, the damping force alleviating the vibrations of the shaft 240 may act in at least two points.

As a result, the vibrations of the shaft 240 may be more stably alleviated.

In addition, since the movement of the lubricating fluid is suppressed at the time of the external impact, a decrease in the amount of lubricating fluid filling between the shaft 240 and the cover member 250 may be suppressed. Therefore, the lubricating fluid may serve to alleviate the impact at the time of the descent of the shaft 240.

As a result, the movements of the lubricating fluid may be suppressed, whereby rigidity may be increased and the damping force alleviating the vibrations of the shaft 240 may be further increased.

As set forth above, even in the case in which the external impact is applied, since the movement suppressing part is provided on the stopper part, such that the movements of the lubricating fluid can be suppressed, whereby the generation of the vibrations may be reduced.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve fixed to a base member and having a depression groove formed in a lower end portion thereof; and
a shaft rotatably supported by the sleeve and having a stopper inserted in the depression groove,
wherein the stopper includes a movement suppressing part provided on an outer peripheral surface thereof in order to suppress movements of a lubricating fluid.

2. The hydrodynamic bearing assembly of claim 1, wherein the movement suppressing part is configured as a plurality of protrusions disposed to be spaced apart from each other in an axial direction.

3. The hydrodynamic bearing assembly of claim 2, wherein each of the plurality of protrusions configuring the movement suppressing part has a quadrangular longitudinal cross-section.

4. The hydrodynamic bearing assembly of claim 1, wherein the shaft has a shaft body having a cylindrical shape and the stopper coupled to a lower end portion of the shaft body.

5. The hydrodynamic bearing assembly of claim 1, wherein the shaft has a shaft body having a cylindrical shape and the stopper extending from a lower end portion of the shaft body outwardly in a radial direction.

6. The hydrodynamic bearing assembly of claim 1, further comprising a cover member installed on the sleeve so as to be disposed below the stopper.

7. A spindle motor comprising:
a base member;
a sleeve fixed to a base member and having a depression groove formed in a lower end portion thereof; and
a shaft rotatably supported by the sleeve and having a stopper inserted in the depression groove,
a cover member installed on the sleeve so as to be disposed below the stopper; and
a rotor hub fixed to an upper end portion of the shaft to thereby rotate together with the shaft,
wherein the stopper includes a movement suppressing part provided on an outer peripheral surface thereof in order to suppress movements of a lubricating fluid.

8. The spindle motor of claim 7, wherein the movement suppressing part is configured as a plurality of protrusions disposed to be spaced apart from each other in an axial direction.

9. The spindle motor of claim 7, wherein each of the plurality of protrusions configuring the movement suppressing part has a quadrangular longitudinal cross-section.

10. The spindle motor of claim 7, wherein the shaft has a shaft body having a cylindrical shape and the stopper coupled to a lower end portion of the shaft body.
